(19) United States
(12) Patent Application Publication
(10) Pub. No.: US 2019/0303499 A1
(43) Pub. Date: Oct. 3, 2019

(54) SYSTEMS AND METHODS FOR DETERMINING VIDEO CONTENT RELEVANCE

(71) Applicant: CBS INTERACTIVE INC., San Francisco, CA (US)

(72) Inventor: Marc Sharma, San Francisco, CA (US)

(73) Assignee: CBS INTERACTIVE INC., San Francisco, CA (US)

(21) Appl. No.: 15/937,916

(22) Filed: Mar. 28, 2018

(51) Int. Cl. G06F 17/30; G06K 9/00

(52) U.S. Cl. CPC G06F 17/30828; G06F 17/3069; G06F 17/30858; G06K 9/00744; G06F 17/30817

(57) ABSTRACT

Systems and methods for making video content recommendations. Metadata relating to at least one content item consumed by the user is received. The video data is stored as at least one video data file for each of the content items and frame change times are extracted for each of the content items from corresponding of the at least one video data file. Frame image files are created for each of the content items based on corresponding sets of the frame times and entity data is extracted from the frame files. Audio data of each of the content items is converted to text data and the entity data and the text data are merged for each content item to create a list of tokens corresponding to each content item. A document vector is determined for each content item based on the list of tokens corresponding to that content item and the similarity of each item of content to each item in a different set of content items is determined based on the vectors. Recommendations of content are presented to a user based on the scores.

### FIELD OF THE DISCLOSURE

The present disclosure relates to systems and methods for determining the relevance of video content to video content consumed by a user.

### BACKGROUND

Automated systems for making product recommendations are well known. For example, U.S. Pat. No. 8,214,264 discloses a system in which collaborative filtering techniques are used to determine physical products of interest to a user. The system computes a similarity measure based upon the number of similar products that match a user's product list and rankings provided by the user and others. It is axiomatic that a core function of a recommendation system is to predict an item worth recommending within a specified context, domain, or situation.

Recommendation systems which make content recommendations, such as a song or an article have also been developed. With respect to audio, visual or text, most current systems involve as a first step finding numeric representations of a corpus of text. Many processes are known for finding such numeric representations. For example, “Sentence2Vec” refers to processes that map a sentence with arbitrary length to vector space. Word vectors are processed to create a sentence vector by, as just one example, averaging the word vectors. Illustration2Vec refers to processes for tagging illustrations and creating image vectors based on the tag. Image2Vec refers to processes for creating vector representations of images. For example, A Visual Embedding for the Unsupervised Extraction of Abstract Semantics, Garcia-Gasulla, D., Ayguadé, E., Labarta, J., Béjar, J., Cortés, U., Suzumura T. and Chen, R., IBM T.J. Watson Research Center, USA (Dec. 19, 2016) teaches a methodology to obtain large, sparse vector representations of image classes, and generate vectors through the deep learning architecture GoogLeNet.

A common factor of all of these methods is word similarity determination. The measures of similarity between two words is usually defined according to the distance between their semantic classes. The word-sense is defined by the word's co-occurrence context such that the context vectors of a word is defined as the probabilistic distributions of its left and right co-occurrence contexts. The most commonly applied version of this technology comes from Tomas Milolov's Word2vec algorithm that captures relationships between words unaided by external annotations. Word2vec utilizes a fully connected neural network, such as neural network 400 illustrated in FIG. 4. Neural network 400 includes an input layer 410, an output layer 430, and a single hidden layer 420, as shown in FIG. 4.

The goal of Word2vec is to produce probabilities for words in the output layer given input words. This is done in Word2vec by converting values of the output layer neurons to probabilities using the softmax function, sometimes referred to as normalized exponential function. The Softmax function is a generalization of the logistic function that “squashes” a K-dimensional vector of arbitrary real values to a K-dimensional vector of real values in the range [0, 1] that add up to 1. In probability theory, the output of the softmax function can be used to represent a categorical distribution—that is, a probability distribution over K different possible outcome.

Content items are converted to a numeric format for finding the distance between them to thereby determine how similar the items of content are to one another. These numeric representations are, for example, word vectors, sentence vectors or document vectors, or a combination thereof. In order to account for context, a context vector can be created with sampling, in a hidden layer of a neural network for example. However, known systems require the calculation of a context vector which is windowed by a specified number of slots which can limit the extraction of contextual generalization.

### SUMMARY

One aspect of the present disclosure relates to a system configured for making video content recommendations based on video content consumed by a user. The system may include one or more hardware processors configured by machine-readable instructions. The processor(s) may be configured to receive metadata relating to at least one content item consumed by the user. The content may include video data and audio data. The processor(s) may be configured to store the video data as at least one video data file for each of the content items. The processor(s) may be configured to extract frame change times for each of the content items from corresponding of the at least one video data file. The processor(s) may be configured to create frame image files for each of the content items based on corresponding sets of the frame times. The processor(s) may be configured to extract entity data for each content item from the sets of frame files. The processor(s) may be configured to convert the audio data of each of the content items to text data. The processor(s) may be configured to merge the entity data and the text data for each content item to create a list of tokens corresponding to each content item based on an id of the content item. The processor(s) may be configured to calculate a document vector for each content item based on the list of tokens corresponding to that content item. The processor(s) may be configured to score the similarity of each item of content to each item in a different set of content items based on the vectors. The processor(s) may be configured to recommend content items in the different set of content items based on the scoring step.

Another aspect of the present disclosure relates to a method for making video content recommendations based on video content consumed by a user. The method may include receiving metadata relating to at least one content item consumed by the user. The content may include video data and audio data. The method may include storing the video data as at least one video data file for each of the content items. The method may include extracting frame change times for each of the content items from corresponding of the at least one video data file. The method may include creating frame image files for each of the content items based on corresponding sets of the frame times. The method may include extracting entity data for each content item from the sets of frame files. The method may include converting the audio data of each of the content items to text data. The method may include merging the entity data and the text data for each content item to create a list of tokens corresponding to each content item based on an id of the content item. The method may include calculating a document vector for each content item based on the list of tokens corresponding to that content item. The method may include scoring the similarity of each item of content to each item in a different set of content items based on the vectors. The method may include recommending content items in the different set of content items based on the scoring step.

Yet another aspect of the present disclosure relates to a non-transient computer-readable storage medium having instructions embodied thereon, the instructions being executable by one or more processors to perform a method for making video content recommendations based on video content consumed by a user. The method may include receiving metadata relating to at least one content item consumed by the user. The content may include video data and audio data. The method may include storing the video data as at least one video data file for each of the content items. The method may include extracting frame change times for each of the content items from corresponding of the at least one video data file. The method may include creating frame image files for each of the content items based on corresponding sets of the frame times. The method may include extracting entity data for each content item from the sets of frame files. The method may include converting the audio data of each of the content items to text data. The method may include merging the entity data and the text data for each content item to create a list of tokens corresponding to each content item based on an id of the content item. The method may include calculating a document vector for each content item based on the list of tokens corresponding to that content item. The method may include scoring the similarity of each item of content to each item in a different set of content items based on the vectors. The method may include recommending content items in the different set of content items based on the scoring step.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this disclosure, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for making video content recommendations based on video content consumed by a user, in accordance with one or more implementations.

FIG. 2 illustrates a method for making video content recommendations based on video content consumed by a user, in accordance with one or more implementations.

FIG. 3 illustrates a schematic of a logical architecture in accordance with one or more implementations.

FIG. 4 illustrates a neural network for similarity processing.

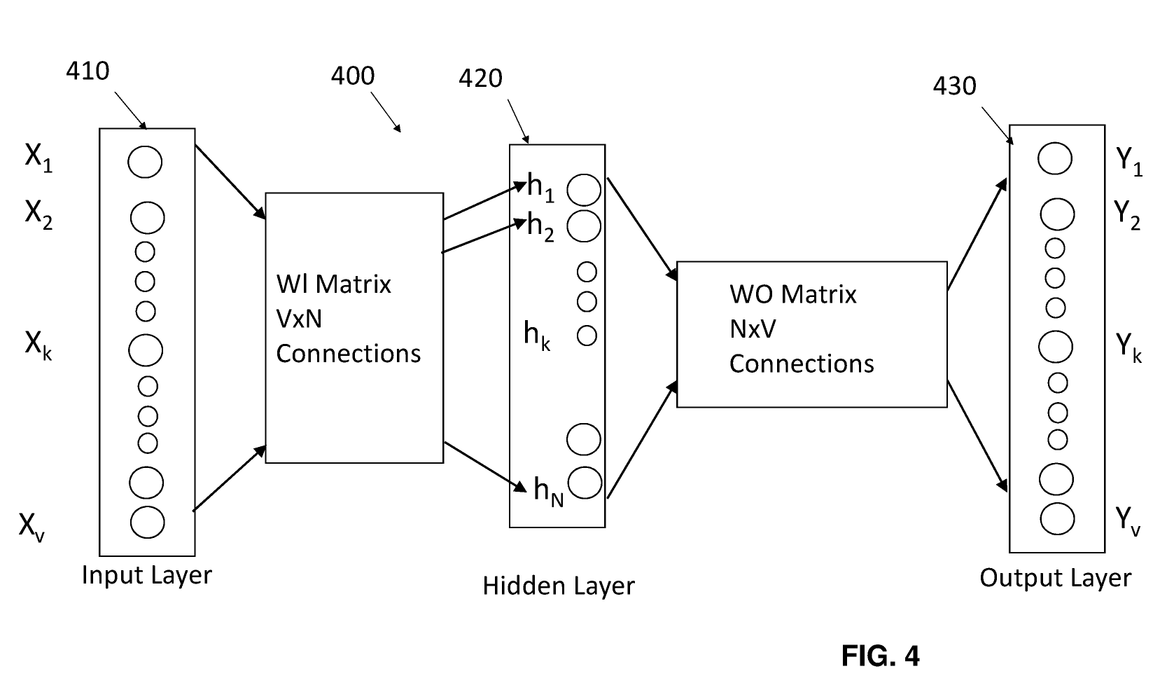

### DETAILED DESCRIPTION

By using a set of semantic vectors, the systems and methods disclosed herein provide a more flexible contextual inference and avoid the necessity of calculating the context vector. Such systems and methods have been found to be very efficient and effective in making video recommendations based on a user's previous consumption of videos. The core function of a recommendation system [RS] is to predict an item worth recommending. Whether the item recommended is formatted as audio, visual or text, most current systems and algorithms involve as a first step finding numeric representations of the corpus of text including amongst others. Examples of such systems/algorithms; sentence2vec, illustration2vec, tweet2vec, image2vec and even emoticon2vec. Whatever the approach, converting plural content items to a numeric format for finding the distance between them gives an idea of how similar the items are.

These numeric representations are the highly sought-after word vectors, or sentence vectors or document vectors. In known systems and algorithms, in order to account for context, a context vector was created with sampling in the hidden layer in order to go from word to concept. The disclosed implementations take this approach further in that the vectors that are produced are built upon a knowledge base of common sense: the ConceptNET5 Numberbatch database, a set of semantic vectors that associates words and phrases in a variety of languages with lists of 600 numbers, representing the gist of what they mean. This novel approach accounts for context by constructing a representation of context as base knowledge. Context can be embedded into the content as tags. The implementations use these pre-defined document embeddings to calculate similarity based on the Earth Mover's distance algorithm. This creates a similarity measure based not simply on individual words, but rather their concepts/semantic meanings.

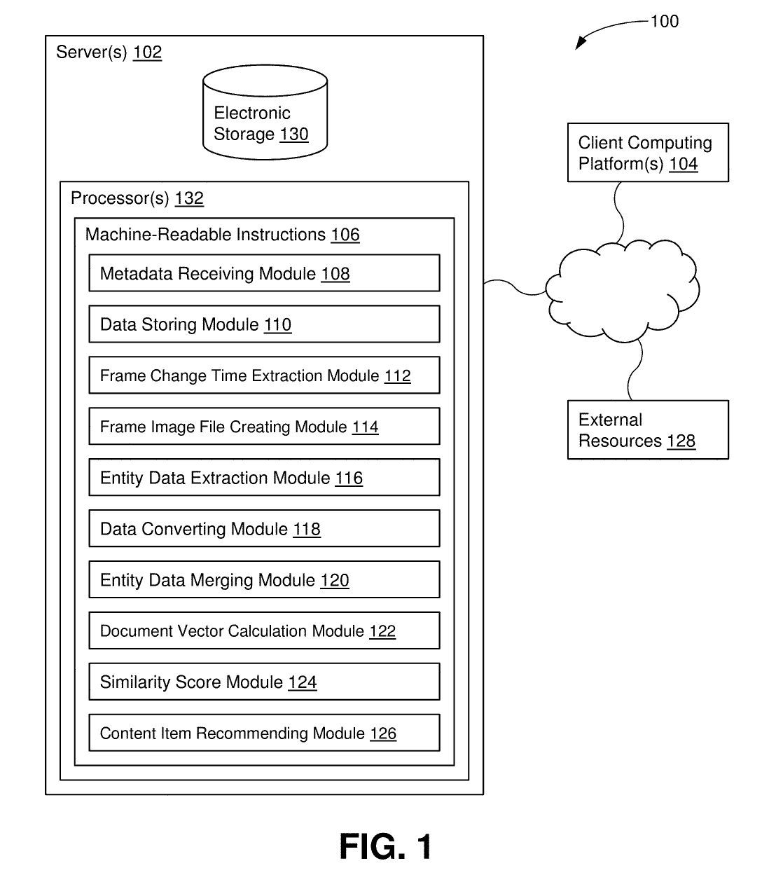

FIG. 1 illustrates a system 100 configured for making video content recommendations based on video content consumed by a user, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of a metadata receiving module 108, a data storing module 110, a frame change time extraction module 112, a frame image file creating module 114, an entity data extraction module 116, a data converting module 118, an entity data merging module 120, a document vector calculation module 122, a similarity score module 124, a content item recommending module 126, and/or other instruction modules. The various modules can include computer-readable instructions recorded on non-transient media and executed by one or more processors.

Metadata receiving module 108 may be configured to receive metadata relating to at least one content item consumed by the user. By way of non-limiting example, the metadata may be stored as a data structure including the fields of date, video_id, user_id, and %_video_watched. The vide_id can be a unique identifier of the video such as an mpxid. The user_id can be a unique identifier of the user such as a unique number assigned to the user by the system. The data field %_video_watched” can be a numeric number representing the amount of a video watched by the user based on user analytics. In some implementations, receiving metadata may include collecting data using a videorobot API (application programming interface).

The content may include video data and audio data. For example, the data can be stored in a compressed format such as in an MP-4 file format, or the like. The video data can be converted from the compressed format to raw video files, such as raster files, as described below. The audio data of each of the content items can be converted to text data by, for example, storing the audio data as flac files and applying a speech-to-text algorithm to the flac files.

Data storing module 110 may be configured to store the video data as at least one video data file for each of the content items. Frame change time extraction module 112 may be configured to extract the times of frame changes, i.e. frame change times for each of the content items from the video data files. Digital video systems represent video frames as rectangular rasters of pixels, either in an RGB color space or a color space such as YCbCr. Standards for the digital video frame raster include Rec. 601 for standard-definition television and Rec. 709 for high-definition television. Video frames are typically identified using SMPTE time code. The identified frames can be correlated to a running time to determine frame change times.

Frame image file creating module 114 may be configured to create frame image files for each of the content items based on corresponding sets of the frame times. Entity data extraction module 116 may be configured to extract entity data for each content item from the sets of frame files. Creating frame image files for each of the content items based on corresponding sets of the frame times may include saving a picture file corresponding to each of multiple times at which a frame change occurs. Entities can be extracted from the frame files using various known tools and techniques. For example, Google Cloud Vision API allows discovery of the content of an image by encapsulating machine learning models in an easy to use REST API. Individual objects and faces within images can be detected.

Data converting module 118 may be configured to convert the audio data of each of the content items to text data. Data converting module 118 can leverage the Google Cloud Speech API, for example. Entity data merging module 120 may be configured to merge the entity data and the text data for each content item to create a list of tokens corresponding to each content item based on an id of the content item. Alternatively, the Google transcription API can be used to extract transcripts of the video directly from the MP4 or other video file without having to first convert to an audio file. The updated dataflow with this taken out is depicted in the attached PDF. I hope this doesn't cause too much of a headache for you. If we remove it from the system, everything else stays the same. The tokens can be a descriptive symbol or element based on an ontology. Tokens can be represented as keywords, symbols, phrases, numbers, or the like. As a simple example, known image recognition techniques can be used to recognize that an image frame includes an automobile. As a result, the token CAR can be assigned to the image frame.

A document vector can be calculated for each content item based on the list of tokens corresponding to that content item may include applying a Conceptnet Numberbatch algorithm, such as Conceptnet 5 Numberbatch. Conceptnet Numberbatch is a set of semantic vectors that associates words and phrases in a variety of languages with lists of 600 numbers, representing the gist of what they mean. Some of the information represented by the vectors can be derived from ConceptNet, a semantic network of knowledge about word meanings. ConceptNet is collected from a combination of expert-created resources, crowdsourcing, and games with a purpose. Document vector calculation module 122 may be configured to calculate a document vector for each content item based on the list of tokens corresponding to that content item. A vector is a quantity or phenomenon that has two independent properties: magnitude and direction. The term also denotes the mathematical or geometrical representation of such a quantity. For example, A 3-Dimensional vector can be represented by a “1-dimensional” array of size 3. 3 numbers in line. A 3×3 matrix can be represented by a “2-dimensional” array, which is what programmers call an array of arrays. Generally, vector similarity can be determined using various known algorithms. ConceptNet Numberbatch consists of state-of-the-art semantic vectors (also known as word embeddings) that can be used directly as a representation of word meanings or as a starting point for further machine learning. ConceptNet Numberbatch is part of the ConceptNet open data project. ConceptNet provides lots of ways to compute with word meanings, one of which is word embeddings. ConceptNet Numberbatch is a snapshot of just the word embeddings. Conceptnet Numberbatch is essentially a ‘repository’ of pre-trained word vectors (That includes improvements on others such as word2vec and Glove). For each word/paragraph/document that is passed to Conceptnet Numberbatch, there is an associated numeric vector that was pre-trained such that it encapsulates semantic meaning that is not necessarily directly calculated. These vectors are then passed into a distance calculation method. Conceptnet Numberbatch was built using an ensemble that combines data from ConceptNet, word2vec, GloVe, and OpenSubtitles 2016, using a variation on retrofitting. It is described in the paper ConceptNet 5.5: An Open Multilingual Graph of General Knowledge, presented at AAAI 2017.

Similarity score module 124 may be configured to score the similarity of each item of content to each item in a different set of content items based on the vectors. Examples of the similarity may include one or more of Earth Movers Distance, analogue, approach, approximation, homogeny, homology, homomorphism, isomorphism, likeness, parallelism, sort, uniformity, and/or other similarities. In some implementations, scoring the similarity of each item of content to each item in a different set of content items based on the vectors may include scoring by applying an “earth mover's distance” (EMD) implementation. EMD is a measure of the distance between two probability distributions over a region D. In mathematics, this is known as the Wasserstein metric. Informally, if the distributions are interpreted as two different ways of piling up a certain amount of dirt over the region D, the EMD is the minimum cost of turning one pile into the other; where the cost is assumed to be amount of dirt moved times the distance by which it is moved.

For example, the open source implementation of EMD in python's pyemd package can be used. Some similarity distance measures, for instance, the popular cosine similarity calculation on a Bag-of-Words fails to capture when documents say the same thing using different words. A well known example taken from the original publication as example are the sentences “Obama speaks to the media in Illinois” vs “The President greets the press in Chicago”. With stop-words removed, these sentences have no words in common. So a standard embedding would find a cosine similarity of 1. EMD is better at capturing semantic similarity between documents than cosine distances.

Recommending content items in the different set of content items based on the scoring step may include storing the results of the scoring step in a lookup table, or other database structure, as an id of each content item and the associated score and presenting, to a user, videos from the lookup table that are above a predetermined threshold. The threshold can be set in advance, or can be dynamically determined. The threshold can be a range.

Content item recommending module 126 may be configured to recommend content items in the different set of content items based on the scores determined in the scoring step. The different set of content items can be content items in a domain, such as content items on YouTube™. The different set of content items can include content times that the user has consumed previously. Content “consumption”, as used herein, refers to any interaction with content, such as viewing the content, listening to the content, receiving the content, requesting the content, and the like. A list of recommended, based on similarity, can be stored as a data structure and presented to the user on a display of client computing platform 104.

In some implementations, server(s) 102, client computing platform(s) 104, and/or external resources 128 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 128 may be operatively linked via some other communication media.

A given client computing platform 104 may include one or more computer processors configured to execute computer program modules. The computer program modules may be configured to enable an expert or user associated with the given client computing platform 104 to interface with system 100 and/or external resources 128, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some implementations, some or all of the functionality attributed herein to external resources 128 may be provided by resources included in system 100.

Server(s) 102 may include electronic storage 130, one or more processors 132, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information, such as data and executable code. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination.

Processor(s) 132 may be configured to execute modules 108, 110, 112, 114, 116, 118, 120, 122, 124, 126, and/or other modules. Processor(s) 132 may be configured to execute modules 108, 110, 112, 114, 116, 118, 120, 122, 124, 126, and/or other modules by software; hardware; firmware; some combination of software, hardware, and/or firmware; and/or other mechanisms for configuring processing capabilities on processor(s) 132. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, and 126 are illustrated in FIG. 1 as being implemented within a single processing unit, in implementations in which processor(s) 132 includes multiple processing units, one or more of modules 108, 110, 112, 114, 116, 118, 120, 122, 124, and/or 126 may be implemented remotely from the other modules. The description of the functionality provided by the different modules 108, 110, 112, 114, 116, 118, 120, 122, 124, and/or 126 described below is for illustrative purposes, and is not intended to be limiting, as any of modules 108, 110, 112, 114, 116, 118, 120, 122, 124, and/or 126 may provide more or less functionality than is described. For example, one or more of modules 108, 110, 112, 114, 116, 118, 120, 122, 124, and/or 126 may be eliminated, and some or all of its functionality may be provided by other ones of modules 108, 110, 112, 114, 116, 118, 120, 122, 124, and/or 126. As another example, processor(s) 132 may be configured to execute one or more additional modules that may perform some or all of the functionality attributed below to one of modules 108, 110, 112, 114, 116, 118, 120, 122, 124, and/or 126.

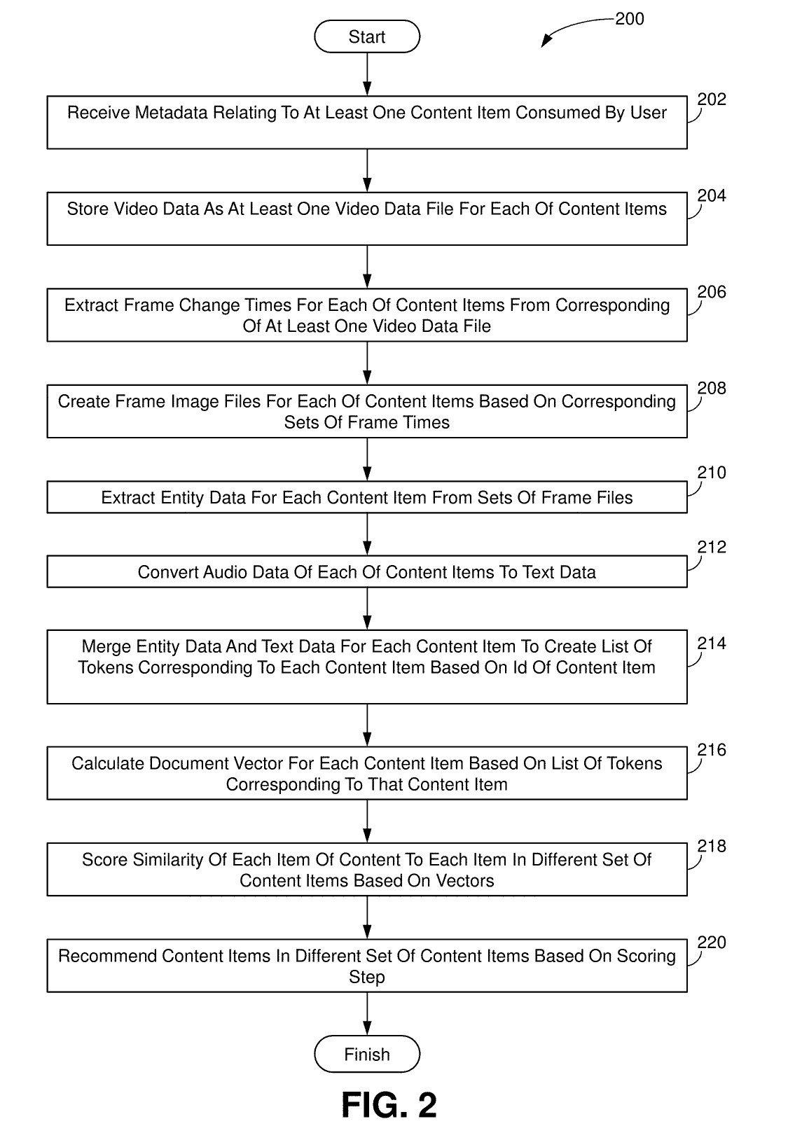

FIG. 2 illustrates a method 200 for making video content recommendations based on video content consumed by a user, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on non-transient electronic storage medium. The one or more processing devices may include one or more devices configured through hardware, firmware, and/or software to be specifically designed for execution of one or more of the operations of method 200.

An operation 202 may include receiving metadata relating to at least one content item consumed by the user. The content may include video data and audio data. Operation 202 may be performed by one or more hardware processors configured by machine-readable instructions including a module that is the same as or similar to metadata receiving module 108, in accordance with one or more implementations.

An operation 204 may include storing the video data as at least one video data file for each of the content items. Operation 204 may be performed by one or more hardware processors configured by machine-readable instructions including a module that is the same as or similar to data storing module 110, in accordance with one or more implementations.

An operation 206 may include extracting frame change times for each of the content items from corresponding of the at least one video data file. Operation 206 may be performed by one or more hardware processors configured by machine-readable instructions including a module that is the same as or similar to frame change time extraction module 112, in accordance with one or more implementations.

An operation 208 may include creating frame image files for each of the content items based on corresponding sets of the frame times. Operation 208 may be performed by one or more hardware processors configured by machine-readable instructions including a module that is the same as or similar to frame image file creating module 114, in accordance with one or more implementations.

An operation 210 may include extracting entity data for each content item from the sets of frame files. Operation 210 may be performed by one or more hardware processors configured by machine-readable instructions including a module that is the same as or similar to entity data extraction module 116, in accordance with one or more implementations.

An operation 212 may include converting the audio data of each of the content items to text data. Operation 212 may be performed by one or more hardware processors configured by machine-readable instructions including a module that is the same as or similar to data converting module 118, in accordance with one or more implementations.

An operation 214 may include merging the entity data and the text data for each content item to create a list of tokens corresponding to each content item based on an id of the content item. Operation 214 may be performed by one or more hardware processors configured by machine-readable instructions including a module that is the same as or similar to entity data merging module 120, in accordance with one or more implementations.

An operation 216 may include calculating a document vector for each content item based on the list of tokens corresponding to that content item. Operation 216 may be performed by one or more hardware processors configured by machine-readable instructions including a module that is the same as or similar to document vector calculation module 122, in accordance with one or more implementations.

An operation 218 may include scoring the similarity of each item of content to each item in a different set of content items based on the vectors. Operation 218 may be performed by one or more hardware processors configured by machine-readable instructions including a module that is the same as or similar to similarity score module 124, in accordance with one or more implementations.

An operation 220 may include recommending content items in the different set of content items based on the scoring step. Operation 220 may be performed by one or more hardware processors configured by machine-readable instructions including a module that is the same as or similar to content item recommending module 126, in accordance with one or more implementations. Scoring is accomplished at 350 and recommendations are made at 360 based on the scoring.

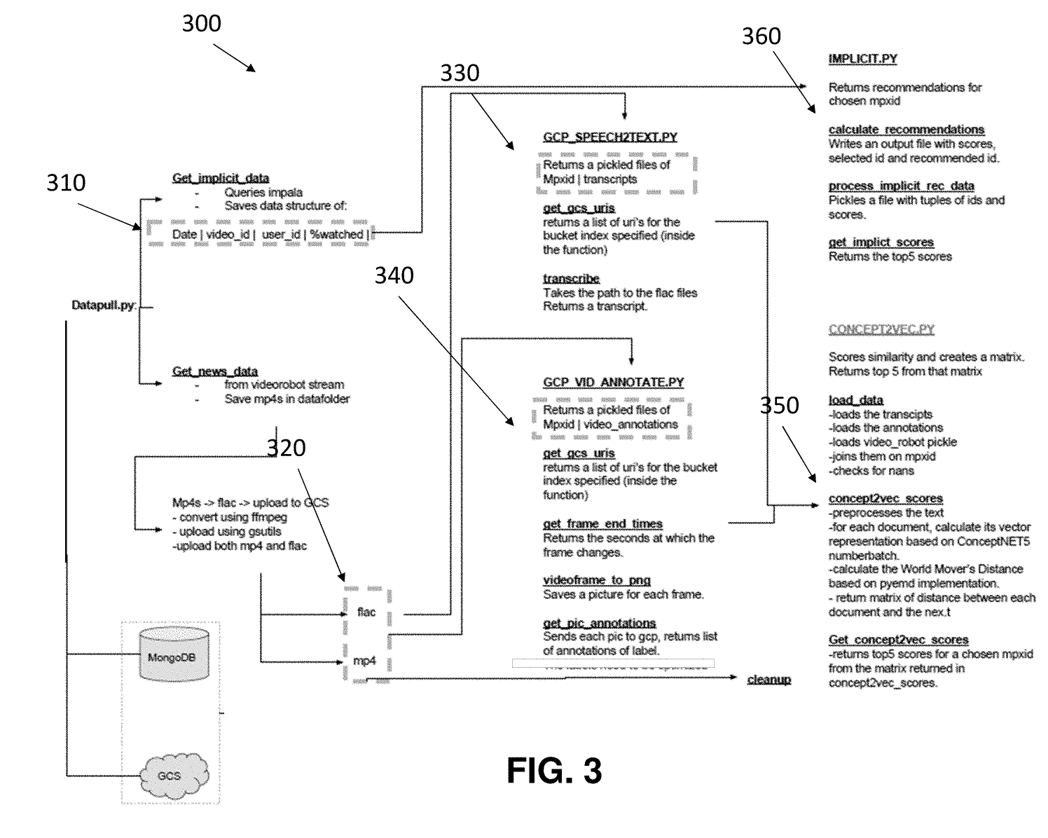

FIG. 3 illustrates a schematic of a logical architecture of a disclosed implementation. Data regarding user video consumption is gathered at 310 and data files are saved at 320. Text data is extracted at 330 and video frame data is created at 340. This logical architecture can be implemented in the computer system of FIG. 1 to accomplish the method of FIG. 2.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for making video content recommendations based on video content consumed by a user, the system comprising:
one or more hardware processors configured by machine-readable instructions to:
receive metadata relating to at least one content item consumed by the user, the content including video data and audio data;
store the video data as at least one video data file for each of the content items;
extract frame change times for each of the content items from corresponding of the at least one video data file;
create frame image files for each of the content items based on corresponding sets of the frame change times;
extract entity data for each content item from the sets of frame image files, wherein the entity data indicates semantic concepts related to at least one object represented in the corresponding frame image file;
convert the audio data of each of the content items to text data;
merge the entity data and the text data for each content item to create a list of tokens corresponding to each content item based on an id of the content item;
calculate a document vector for each content item based on the list of tokens corresponding to that content item, whereby the document vector is a representation of objects represented in the content item;
score the similarity of each item of content to each item in a different set of content items based on the vectors; and
present to the user content items in the different set of content items based on the scoring step.

2. The system of claim 1, wherein the step of receiving metadata comprises collecting data using a videorobot application programming interface (API).

3. The system of claim 1, wherein the step of storing the video data as at least one video data file for each of the content items comprises converting the video files from a compressed format to raw video files.

4. The system of claim 1, wherein the step of calculating a document vector for each content item based on the list of tokens corresponding to that content item comprises applying a conceptnet 5 numberbatch algorithm.

5. The system of claim 1, wherein the step of scoring the similarity of each item of content to each item in a different set of content items based on the vectors comprises scoring by applying an earth mover's distance implementation.

6. The system of claim 5, wherein the step of recommending content items in the different set of content items based on the scoring step comprises storing the results of the scoring step in a lookup table as an id of each content item and the associated score and presenting to a user videos from the lookup table that are above a predetermined threshold.

7. The system of claim 1, wherein the metadata is stored as a data structure including the fields of date, video id, user id, and % video watched.

8. The system of claim 1, wherein the step of converting the audio data of each of the content items to text data comprises storing the audio data as flac files and applying a speech to text algorithm to the flac files.

9. The system of claim 1, wherein the step of creating frame image files for each of the content items based on corresponding sets of the frame times comprises saving a picture file corresponding to each of multiple times at which a frame change occurs.

10. A method for making video content recommendations based on video content consumed by a user, the method comprising:
receiving metadata relating to at least one content item consumed by the user, the content including video data and audio data;
storing the video data as at least one video data file for each of the content items;
extracting frame change times for each of the content items from corresponding of the at least one video data file;
creating frame image files for each of the content items based on corresponding sets of the frame change times;
extracting entity data for each content item from the sets of frame image files, wherein the entity data indicates semantic concepts related to at least one object represented in the corresponding frame image file;
converting the audio data of each of the content items to text data;
merging the entity data and the text data for each content item to create a list of tokens corresponding to each content item based on an id of the content item;
calculating a document vector for each content item based on the list of tokens corresponding to that content item, whereby the document vector is a representation of objects represented in the content item;
scoring the similarity of each item of content to each item in a different set of content items based on the vectors;
present to the user content items in the different set of content items based on the scoring step.

11. The method of claim 10, wherein the step of receiving metadata comprises collecting data using a videorobot application programming interface (API).

12. The method of claim 10, wherein the step of storing the video data as at least one video data file for each of the content items comprises converting the video files from a compressed format to raw video files.

13. The method of claim 10, wherein the step of calculating a document vector for each content item based on the list of tokens corresponding to that content item comprises applying a conceptnet 5 numberbatch algorithm.

14. The method of claim 10, wherein the step of scoring the similarity of each item of content to each item in a different set of content items based on the vectors comprises scoring by applying an earth mover's distance implementation.

15. The method of claim 14, wherein the step of recommending content items in the different set of content items based on the scoring step comprises storing the results of the scoring step in a lookup table as an id of each content item and the associated score and presenting to a user videos from the lookup table that are above a predetermined threshold.

16. The method of claim 10, wherein the metadata is stored as a data structure including the fields of date, video id, user id, and % video watched.

17. The method of claim 10, wherein the step of converting the audio data of each of the content items to text data comprises storing the audio data as flac files and applying a speech to text algorithm to the flac files.

18. The method of claim 10, wherein the step of creating frame image files for each of the content items based on corresponding sets of the frame times comprises saving a picture file corresponding to each of multiple times at which a frame change occurs.

19. A non-transient computer-readable storage medium having instructions embodied thereon, the instructions being executable by one or more processors to perform a method for making video content recommendations based on video content consumed by a user, the method comprising:
receiving metadata relating to at least one content item consumed by the user, the content including video data and audio data;
storing the video data as at least one video data file for each of the content items;
extracting frame change times for each of the content items from corresponding of the at least one video data file;
creating frame image files for each of the content items based on corresponding sets of the frame change times;
extracting entity data for each content item from the sets of frame image files, wherein the entity data indicates semantic concepts related to at least one object represented in the corresponding frame image file;
converting the audio data of each of the content items to text data;
merging the entity data and the text data for each content item to create a list of tokens corresponding to each content item based on an id of the content item;
calculating a document vector for each content item based on the list of tokens corresponding to that content item, whereby the document vector is a representation of objects represented in the content item;
scoring the similarity of each item of content to each item in a different set of content items based on the vectors;
present to the user content items in the different set of content items based on the scoring step.

20. The computer-readable storage medium of claim 19, wherein the step of receiving metadata comprises collecting data using a videorobot application programming interface (API).

21. The computer-readable storage medium of claim 19, wherein the step of storing the video data as at least one video data file for each of the content items comprises converting the video files from a compressed format to raw video files.

22. The computer-readable storage medium of claim 19, wherein the step of calculating a document vector for each content item based on the list of tokens corresponding to that content item comprises applying a conceptnet 5 numberbatch algorithm.

23. The computer-readable storage medium of claim 19, wherein the step of scoring the similarity of each item of content to each item in a different set of content items based on the vectors comprises scoring by applying an earth mover's distance implementation.

24. The computer-readable storage medium of claim 23, wherein the step of recommending content items in the different set of content items based on the scoring step comprises storing the results of the scoring step in a lookup table as an id of each content item and the associated score and presenting to a user videos from the lookup table that are above a predetermined threshold.

25. The computer-readable storage medium of claim 19, wherein the metadata is stored as a data structure including the fields of date, video id, user id, and % video watched.

26. The computer-readable storage medium of claim 19, wherein the step of converting the audio data of each of the content items to text data comprises storing the audio data as flac files and applying a speech to text algorithm to the flac files.

27. The computer-readable storage medium of claim 19, wherein the step of creating frame image files for each of the content items based on corresponding sets of the frame times comprises saving a picture file corresponding to each of multiple times at which a frame change occurs.
